(19) United States
(12) Patent Application Publication
(10) Pub. No.: US 2015/0184449 A1
(43) Pub. Date: Jul. 2, 2015

(54) WINDOW ATTACHABLE BLIND SYSTEM

(71) Applicant: Emily Jourdan, Austin, TX (US)

(72) Inventor: Emily Jourdan, Austin, TX (US)

(21) Appl. No.: 14/578,300

(22) Filed: Dec. 19, 2014

Related U.S. Application Data
(60) Provisional application No. 61/922,827, filed on Jan. 1, 2014.
(60) Provisional application No. 61/922,828, filed on Jan. 1, 2014.

(51) Int. Cl. E06B 9/26

(52) U.S. Cl. CPC E06B 9/26

(57) ABSTRACT

An easily attachable window blind or shade bracket and blind system allows non-destructive attachment of a temporary blind or shade to a surface such as a wall or window, blocking light and/or covering the opening or a portion of the surface. The blind or shade is of simple and inexpensive construction, and can be easily changed out without removal of the bracket which holds it in place. This allows use of decorative blinds or shades which can be readily changed out for different occasions, or placed for temporary insulation for a hot or cold season. It also allows use of blinds or shades in buildings such as rental, student, hospital or historic buildings where no damage can be allowed to surfaces such as window frames, door frames and walls, or blinds or shades may be frequently changed.

### CROSS REFERENCE TO RELATED APPLICATIONS

This application is a U.S. Utility application taking priority from U.S. Provisional application No. 61/922827 filed Jan. 1, 2014, and U.S. Provisional application No. 61/922828 filed Jan. 1, 2014, both herein incorporated by reference.

### BACKGROUND OF THE INVENTION

The current invention relates to a low-cost replaceable window covering system or blind for windows. More particularly, this invention relates removably attaching a pleated shade and a holder for the shade directly to the glass or interior structure of a window, rather than to the outer frame of the window. This has several advantages, one of which is that no tools are needed for installation, since the window does not have nails or screws inserted as is the case with conventional shades which have brackets attaching to a window frame. Another advantage is that no damage is done to the frame of the window, which is convenient for situations such as rental properties, where the landlord may not allow holes to be made, properties being placed for sale, where it may be undesirable to place holes and brackets if a new owner will want a different configuration, historic buildings where no damage to the structure can be allowed, or in a building where people frequently change residences such as student dorms, which may have turnover each quarter or semester. Finally, easy interchangeability of shades allows for temporary decoration of windows for special events or seasons, or changing out of window treatments in a hospital where disease or germ transfer could occur between patients.

### REFERENCES

Prior art removable pleated blinds are typically attached all as one piece to a window or a window frame at the top of the blind with an adhesive strip. These blinds may take the form of rectangular shades or, in the case of arched windows, approximately semicircular or circular shades which may “fan out” to cover the arch. Such fan structures could potentially have other shapes to cover, for example, a window in the shape of a pointed arch.

U.S. Pat. No. 5,158,127 to Schumacher shows a temporary covering for a window or the like, including an elongated paper-like sheet having equidistant parallel pleats defined by creases extending across the sheet. An adhesive fastening strip is located at the top end of the sheet for fastening the sheet to a window, window frame, or the like. When mounted to a window or a window frame, the temporary window covering extends downwardly to a selected variable length, while maintaining a pleated appearance.

U.S. Pat. No. 8,136,568 to Debauche describes a shade for an arched window including an arched track with a movable carriage and a shade member attached to the carriage. A cord actuates the carriage to move along the track and pull the shade member between collapsed and extended positions. A central hub permits the shade member to move laterally as the shade member is moved between the collapsed and extended positions.

U.S. Pat. No. 7,721,782 to Foley et. al. describes an arched window covering comprising a head rail that is mounted to an architectural feature. A mounting track is mounted to the arched architectural feature and a slider track is snap fit to the mounting track. The slider track includes support portions extending therefrom that slidably support a plurality of sliders such that the sliders can be moved relative to the slider track. The sliders are connected to a shade panel such that movement of the sliders on the slider track results in the extension and retraction of the shade panel.

U.S. Pat. No. 7,650,922 to Alberti describes a window treatment for an arch-shaped window including a frame having an arch portion and a horizontal portion; at least one shade panel pivotally connected to a central portion of the horizontal portion of the frame; at least one channel formed on an inner surface of the arch portion, wherein the at least one channel forms a longitudinal slot on an inner surface thereof; and a chain at least partially housed within the at least one channel and moveable therein for effectuating arcuate movement of the at least one shade panel between an open and a closed position, wherein the chain is configured and dimensioned to move within the at least one channel without falling out of the longitudinal slot.

U.S. Pat. No. 7,188,658 to Nordstro et al describes a retractable window covering for arched or palladian style windows. The covering has a pair of shade members that can be remotely operated by an activator such as a pull cord for opening and closing the shades. The shade members are suspended from a carriage that is movable within an arched track. The shade members can be drawn along the track in opposite directions independently from a horizontal retracted position to an expanded position such that the shade members meet at the apex of the arched window.

U.S. Pat. No. 7,249,623 to Chhun describes an improved bracing bracket for arched window blinds including a protrusive seat which has a wedge notch on the top rim to couple with a mating plank so that the coupled protrusive seat and the plank may serve as the installation basis. A left material and a right material may be bonded to two sides of the plank. The protrusive seat has a mark in the center of the front side and the rear side to align with a window sill to bond the bracing bracket to the window sill without skewing to facilitate fast installation.

The Chhun patent describes other prior art including U.S. Pat. No. 6,145,569) which illustrates an arched window blind with a one-way extendable blind mounted on one side of a window sill and a bracing bracket to hold the blind. The bracket includes a base and arched tracks to guide extension of the blind. Chhun also describes U.S. Pat. No. 5,010,939 which includes a bracing bracket D containing a center axle to couple with two sets of blinds on the periphery. Chhun also describes U.S. Pat. No. 5,002,112 which includes a bracing bracket with an arched seat and a center plank with two side planks. The side planks are respectively coupled with inset planks. A window shade has a hollow material to couple on the center plank. Then two sides of the window shade are bonded to the side planks to brace the window shade on the bracing bracket.

U.S. Pat. No. 5,794,680 to Xue describes retractable arced window covering for arced windows. The window covering is a pleated fan covering for arced windows which can be remotely operated by a pull cord for opening and closing the covering. The arced window covering includes a base which hides the retracted covering, a first arced track extending from the base, and a foldable pleated member which is suspended from the track and can be drawn along the track using a cord. Both embodiments of the arced window covering include a locking mechanism capable of holding the cord and the foldable pleated member in a selected position. U.S. Pat. No. 5,044,418, issued on Sep. 3, 1991, to Nadine G. Donahue describes an arch-shaped window treatment having a frame and a flexible fabric mounted thereon.

U.S. Patent Publication No. 20050126716 to Militello et al describes an assembly for shading an arched window. The assembly includes a shade portion preferably in the form of a pleated shade extending between a first end and a second end. The ends of the shade are positioned so that the shade portion takes on a fanned configuration of semi-circular form similar to that of the arched window. A retainer acts as a support to hold the shade in a vertical orientation adjacent the window. The retainer includes a guide in the form of at least one panel extending up from a base resting upon a sill below the window. The panel buttresses the shade by contacting an intermediate portion of the shade between ends thereof to keep the shade in the vertical orientation shading the arched window.

The present invention has several advantages over the prior art blind structures. First is simplicity of operation, in that in a preferred embodiment there are no mechanical systems such as a roller, cords or pulley systems for moving the blind up and down, or folding and unfolding it in the case of a fan-shaped blind. This reduces cost significantly, an important consideration for a removable or temporary window blind. Secondly, the present invention allows separation of the blind section from the adhesive bracket. Since in the preferred embodiment there is little or no hardware within the replaceable blind section, the replaceable blind section can be built almost entirely of inexpensive, flexible material. In this way, inexpensive blinds made of paper plastic, cloth or fabric, potentially with different decorations, can be easily and quickly removed and attached from the bracket or mounting system without the need for changing the bracket out.

Because the mounting system does not interfere with conventional wall mounted curtains or blinds with wall mounted brackets and in its preferred embodiments does not damage surfaces, the blinds of the subject invention can be temporarily mounted purely as decorations for special events.

### SUMMARY DISCLOSURE OF INVENTION

A holder and a pleated shade provide a temporary or permanent window covering assembly for a window. The window may be a typical rectangular window, which may include the square subset of rectangles, or may have an approximately semi-circular or arched section, but may be other shapes. One aspect of the current invention is to provide low cost pleated shades that are easy to replace or interchange so that shades can be replaced for different seasons, holidays, or other occasions.

In one embodiment, a shade assembly for a semi-circular or arched window section includes a rectangular pleated shade that can be unfolded into a fanned configuration between the ends. A holder or bracket retains the unfolded shade on a window sill or on a window around the bottom of the semi-circular window section. In various examples, the holder comprises a base which rests on, or is affixed to, a window sill. The base includes a recess or clip for retaining a first folded end of the pleated shade. The first folded end may be cut to a desired length so that the unfolded fan covers the arched window. The shade is typically provided in a folded and pleated form, cut to desired width, inserted into a holder, and then unfolded to a decorative pleated rosette form with the pleats radiating from a gathered end at the holder.

The arched or semi-circular windows typically include a sill located at approximately the location the semi-circular or arched section ends, and the window transitions to a rectangular shape. In the event that a sill is not present, a shelf can be provided to support the shade assembly, or the holder can be attached directly to the window via adhesive.

In any embodiment of this invention, the removable pleated shade section is typically provided as a paper material. In other examples, fabric can be used with a chemical or mechanical stiffener such as wood or plastic, or a plastic material can be used. The shade may be cut to fit various sizes of windows.

The holder for the removable pleated shade section is typically secured to a window sill or frame with adhesive, hook and loop fastener, suction cups, or other removable means which do not require damaging or making holes in the sill or frame. A decorative element is typically provided to conceal the shade holder as viewed from either the inside or outside of the room with the window.

In one example, a first pattern is provided on the inside-facing portion of a pleated shade so that the first pattern is visible from the inside of a room. A second color or pattern is provided on the outside-facing portion of a pleated shade so that the second color or pattern is visible from the outside of the room through the opening or window the shade covers. The second pattern or color may be the same or different from the first pattern or color.

### BRIEF DESCRIPTION OF DRAWINGS

FIG. 1 shows a front view of an embodiment of a rectangular window covering system of the current invention, with the removable shade below the shade holder.

FIG. 2 shows a cross section side view of the window covering system of FIG. 1.

FIG. 3 shows a perspective view of the parts of an embodiment of a fan-fold window covering system of the current invention for a semi-circular window section.

FIG. 4 shows a detail view of the removable bracket and holder for the bottom of the fan-fold window covering system of FIG. 3, with an example of a spring clip to hold the bottom of the pleated shade.

FIG. 5 shows a detail view of the removable bracket and holder for the bottom of the fan-fold window covering system of FIG. 3, with an example of a narrowed section to hold the bottom of the pleated shade.

FIG. 6 shows a front view of an embodiment of a fan-fold window covering system of the current invention in front of a semi-circular window section.

### MODE(S) FOR CARRYING OUT THE INVENTION - DETAILED DESCRIPTION

The present invention and its various embodiments are described below, with reference to figures as necessary. Reference numbers are used to match particular elements described in the text with those shown in figures. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

Generally speaking, the present invention describes an apparatus and associated methods of operation and installation of a removable window blind or shade system. In a preferred embodiment, the blind system is intended to be attached to a window or window frame without damage (e.g. without nail or screw holes) to the window or frame. This attachment may be by means of systems such as, but not limited to, adhesives, suction cups, hook and loop type fasteners, magnets, and mounting clay type materials. Attachment to a window or frame takes place at a bracket or holder, which would hold a separable folded or rolled flexible blind type material, which blind type material could be stretched or fanned out to cover the window. The separable blind type material can be removed from the bracket or holder, which can stay attached to the window or frame. This allows easy replacement of the blind, for changes in the primary decorative element or changes in light blocking, while leaving the bracket or holder in place.

In this specification, the terms ‘blind’, “shade, ‘pleated shade’ or ‘pleated paper blind’ refers to temporary or permanent shades made of paper, plastic, or fabric. In the case of fabric, a chemical or mechanical stiffener, such as wood, resin or plastic, is typically provided. In a preferred embodiment stiffening members are used at the top and bottom of the blind 105 to keep it rigid across the window. Stiff but flexible members may also be used along outer edges of the blind in order to match the shape of the blind to a particular window.

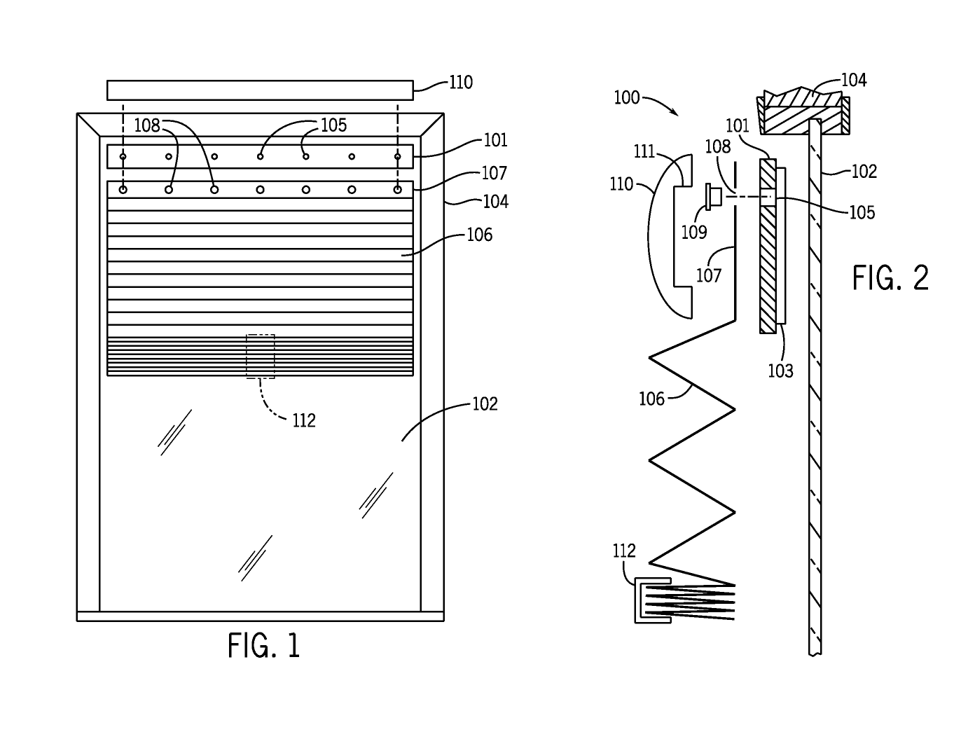

FIG. 1 and FIG. 2 show an embodiment of the blind assembly 100. Bracket 101 is attached to the upper portion of a window 102 by means of adhesive 103. Note that although this embodiment is attached to the window using an adhesive, other attachment systems such, but not limited to, as suction cups, hooks and loops, magnets, and mounting clay type materials can also be used. These fastening systems could be affixed to the bracket 101 to removably attach bracket 101 to the window 102, or could be affixed to window 102 to removably attach bracket 101 to the window 102, or could have portions affixed to the bracket 101 and portions affixed to window 102 to removably attach the bracket portion to the window portion. Bracket 101 could also be attached to a window's frame 104, if adhesive 103 were on the top side of bracket 101 (not shown) instead of the window-facing side. In this example, the bracket 101 is a plastic material. In other examples, the bracket may be constructed of wood, metal, resin, glass, or other materials.

Bracket 101 has holes 105 distributed along it. Blind or shade 106 is partially horizontally collapsed. Collapsed in these embodiments means a spreadable sheet of some flexible or semi-flexible material is gathered together in a way to make it more compact. Forms of collapse can include, but are not limited to, crumpling, rolling, folding, and the commonly used for blinds special case of folding, pleating, an evenly distributed zig-zag set of folds, as shown for blind 106 in FIG. 1 and FIG. 2. In preferred embodiments, the form of collapse for the blinds is reversible, so that the blind can be gathered and spread so as to cover different amounts of an opening or window as desired. Horizontally pleated blind or shade 106 has a reinforced strip 107 at its top with holes 108 which match holes 105 in the bracket 101. Pegs 109 can be inserted into holes 108 in strip 107 and holes 105 in bracket 101 to hold blind 106. Note that while in this embodiment pegs 109 are shown as a blind retainer to hold blind 106 to bracket 101, other systems could be used to hold on blind 106, such as, but not limited to, hooks, spring clips, snaps, buttons, one or more zippers, laces, straps, adhesive, magnets, and hook and loop structures. Similarly the pegs 109 could be fixed in bracket 101, and the holes 108 on reinforced strip 107 can go over the pegs. These blind retainer systems may be distributed along the bracket 101, or may be only at the center or ends of the bracket 101. Note that while horizontal pleats or folds are shown in FIG. 1 and FIG. 2, vertical pleats or folds, that is pleats running up and down, could also be used with a blind which spreads horizontally and is placed on pegs or other blind retainer elements to cover the window. Finally, a removable cover 110 covers the pegs 109. This cover may have a recess or recesses 111 to go over pegs 109. Note that while pegs are shown as a blind retainer element in this embodiment, other systems such as, but not limited to, screws, twist-locks, and tacks could be used to hold blind 106 to bracket 101. The pegs 109 or other fasteners may also be integrated with cover 110 or bracket 101.

Blind 106 can be raised and lowered in front of window 102, and can be held in desired positions covering portions of window 102 by using retention element 112. While a clip is shown here for retention element 112, other systems such as, but not limited to, a spring clamp, a band, laces, hooks, magnets and snaps could be used to hold the bottom of the blind 106 in a particular position. It may also be desirable to use multiple retention elements 112 to hold the bottom of the blind 106 more evenly. In an alternative embodiment, cords can be used to raise and lower the blinds. In other embodiments of this invention, the bottom edge of the blind 106 may be held down at the bottom of window 102 by systems including, but not limited to, weights, adhesive, magnets, an installable catch, or hooks and loops such as Velcro™.

In other embodiments of this invention, the width of bracket 101, blind 106 and cover 110 may be adjusted to match the width of window 102. This adjustment may be by snapping or cutting extra length from bracket 101 and cover 110, and by cutting or tearing off by means of perforations extra width from blind 106. Perforations can be placed at intervals along the sides and bottom edges of blind 106 so that strips of varying width can be torn off, providing a way to adjust the width and length of blind 106 while keeping straight lines along the sides and bottom of blind 106 for improved appearance, since it can be difficult to cut long, straight lines with scissors. Alternatives to perforations can be weakened or thinned sections of the blind to allow tearing off of uniformly wide strips and providing a reasonably finished edge.

In other examples, the bracket or holder attachment element 101 may be mechanically attached to the window frame, such as by screws or nails. The blind 106 is still designed to be removable from the bracket 101.

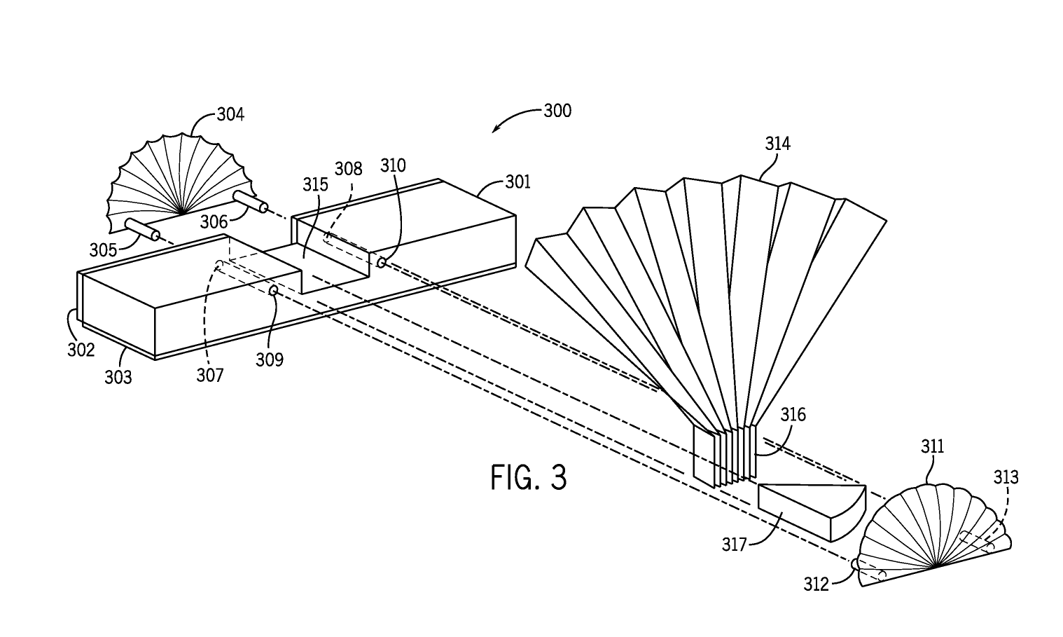

In another embodiment of this invention, shown in FIG. 3, the system 300 is adapted for providing a covering for a semi-circular or arched type window. Bracket 301 is attached to a window (601, shown in FIG. 6) by means of adhesive 302. Note that, instead of being attached to the window by the adhesive 302 on the back side of the bracket 301, the bracket 301 can alternatively or additionally be attached by the adhesive 303 on the bottom side of the bracket 301 to a frame (602, shown in FIG. 6) of the window, if there is a suitable frame or sill on the window. If there is no suitable frame a shelf can be added. In this example, the bracket 301 is a plastic material. In other examples, the bracket may be constructed of wood, metal, resin, glass, or other materials.

In this embodiment a cover 304 is shown on the window or outward facing side of the bracket 301. This cover 304 may be decorative on one or both sides, as shown here with scalloping, and may, as shown, protrude above the top of the bracket 301 or may not protrude above the top of the bracket. The cover 304 is shown with two pegs 305 and 306 which can be fit into holes 307 and 308 in the outward facing side of bracket 301. Alternatively, cover 304 can be made part of bracket 301 if it does not need to be changed out for decorative reasons. Also in this embodiment are shown two holes 309 and 310 where another cover 311 can be attached, using pegs 312 and 313 fitting into holes 309 and 310. Note that while pegs are shown for attachment in this embodiment, clearly other fastening systems including, but not limited to, snaps, adhesive, screws, nails, hook and loop, magnets and press-fit edge snaps could be used to attach cover 311. As with cover 304, cover 311 may have decorative elements on one or both sides and may or may not protrude above the top of the bracket 301. Covers 304 and 311 may also be wide enough to completely cover bracket 301, such as for decorative purposes.

Covers 304 and 311 are used to hold pleated blind or shade 314 in slot 315. In this embodiment the blind is collapsed vertically, with the form of collapse being pleats. Since the pleats of the blind are arranged vertically, one end of the collapsed blind can be compressed and fastened in place while the other end can be spread out like a fan to cover the semi-circular window section. In particular the compressed section 316 of pleated shade 314 fits into slot 315, and provides the interchangeability of blinds which is a feature of this invention. The sides of slot 315 may also have “grippy” surfaces which are roughened, textured or elastomer covered to improve their ability to hold blind section 316 in place. They may also have one or more magnets which match magnets in compressed section 316 of pleated shade 314 in order to hold shade 314 in place.

FIG. 3 also shows one embodiment of a blind retaining element system to help hold compressed blind section 316 into slot 315, a wedge 317. This wedge 317 can be pressed or tapped into the slot 315 after blind section 316 has been placed into slot 315. The wedge 317 and blind section 316 can then be held in place by cover 311. Note that while a wedge shaped, e.g. having a triangular cross section when viewed from above, piece 317 is shown, obviously a variety of cross sections of insertable pieces could be used as blind retaining elements, depending on the slot 315 and pleated blind end 316 configuration. The wedge or wedges could also be incorporated into cover 311, so that when the cover is placed on the bracket 301 the blind end 316 is compressed and held in place. In this case, tracks instead of pegs for cover 311 may be desirable, and a downwards facing wedge, so that when the cover 311 is slid down into place, the wedge locks blind end 316 into place. The surfaces of the wedge 317 may also have “grippy” surfaces which are roughened, textured or elastomer covered to improve their ability to hold blind section 316 in place. While a single wedge 317 is shown, clearly more than one wedge can be used to help hold compressed blind section 316 into slot 315.

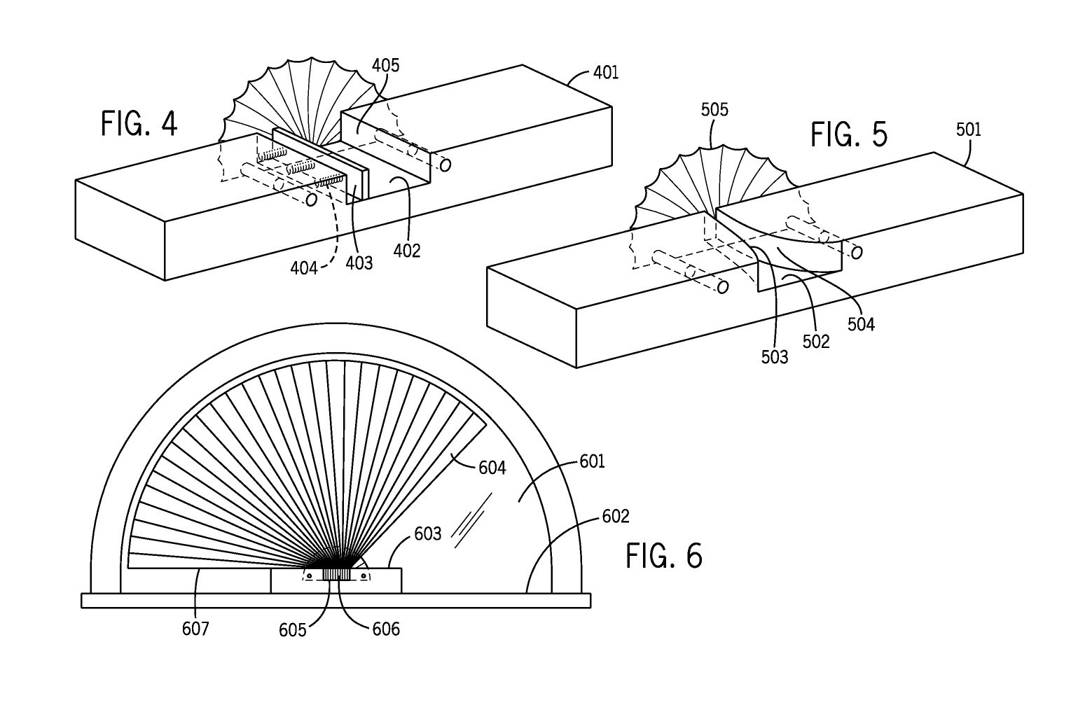

FIG. 4 shows another embodiment of a blind retaining element system with a bracket 401 to help hold compressed blind section 316 (shown in FIG. 3) into slot 402 (the equivalent of slot 315 in FIG. 3), a side plate 403 with one or more springs 404. The plate 403 and spring or springs 404 can be compressed, the blind section 316 can be inserted into slot 402 and the plate released to hold blind 314 (shown in FIG. 3) in slot 402 on bracket 401 (the equivalent of bracket 301 in FIG. 3). Note that while a plate 403 and spring 404 are shown on one side of slot 402, it would obviously be possible to have another plate and spring on the other side 405 of slot 402, providing compression of blind section 316 from both sides. In addition, the plate 403 or plates used as blind retaining elements may have shapes other than flat to help hold blind section 316 in place in slot 402, such as notched, concave or convex. The plate 403 or plates may also have “grippy” surfaces which are roughened, textured or elastomer covered to improve their ability to hold blind section 316 in place.

FIG. 5 shows another embodiment of a blind retaining element system with a bracket 501 to help hold compressed blind section 316 (shown in FIG. 3) into slot 502 (the equivalent of slot 315 in FIG. 3), curved side walls 503 and 504 of slot 502. These would allow the user to push blind section 316 into slot 502 and provide enough compression on the pleated section 316 to hold section 316 and thereby blind 314 in place in front of window 601 (shown in FIG. 6). While inwardly curved sides 503 and 504 are shown, it would clearly be possible to have only one curved side, or to have one or more angled instead of curved side or sides. An angled side may have multiple angles in it, for example the inward facing ends of slot 502 towards the interior of the room may be angled inwards, towards the center of the slot 502, while the remainder of the walls of slot 502 closer to outward facing slot cover 505 may have parallel sides to compress then hold blind section 316 in place in slot 502 and thereby bracket 501.

Other compression systems used as blind retaining elements for the compressed blind section 316 can include, but are not limited to, a horizontal or vertical hinge, a vertically tapered slot, and a compression fitting.

FIG. 6 shows an embodiment of the fan-shaped version of this invention covering a semi-circular window 601 with lower frame 602. The bracket 603 may be adhesively mounted to the window 601 using adhesive 302 (shown in FIG. 3) on the side of the bracket 603 facing the window 601, or the lower frame 602 using adhesive 303 (shown in FIG. 3) on the side of the bracket 603 facing the lower frame 602, or both. Once bracket 603 is fastened in place, the pleated blind 604 can be removably placed in slot 605 of bracket 603 by compressing the blind end section 606, placing the blind section 606 in slot 605 and, if necessary, using one of the fastening mechanisms described in previous figures to help hold blind section 606 in slot 605.

Then blind 604 can be spread out, in FIG. 6 the left hand side of blind 604 is shown fully spread to approach frame 602. In order to completely cover and thereby darken window 601, bracket 603 could be widened to cover the frame of the window, in which case it would need to be measured and possibly shortened to match the length of the frame. In another embodiment, the spreading edges of blind 604 could be shaped to match the length of the bracket 603 and have flaps or wings which extended below the 90 degree point to cover the window, while the main edge of the fanned out blind would only reach to 90 degrees. In another embodiment the edges of blind 604 could be spread or fanned past 90 degrees to completely cover the window. In any of these embodiments, the edges of blind 604 can be fastened to the frame 602 of window 601 by systems including, but not limited to, weights, adhesive, magnets, an installable catch, or hooks and loops such as Velcro™ in order to keep the blind spread or fanned out. These fastening systems may be attached to the window frame 602, or may be attached to the top of the bracket 603, depending on how bracket 603 is configured.

While this embodiment was illustrated for a semicircular window with bracket 603 at the center of the bottom of the semi-circular window 601, in the case of an arched window it may be preferable to attach the bracket 603 at the top of the window, at the arch, and to shape the blind so as to have a flat side facing downwards when it is spread or fanned out. This may also necessitate using bendable frames at the spreading edges of blind 604 so that as blind 604 is spread, it meets up with the curved window arch sides and the blind will retain the shape of the window when spread out to thereby cover the window. As with the rectangular blind, the size of the blind 604 can be adjusted to cover different sized windows 601 by cutting or tearing off strips from one or both ends of the pleated blind 604. Similarly, this single point attached fan-type blind could be used to cover rectangular windows, if the blind has an appropriate shape when spread.

In one embodiment of both the rectangular and semi-circular blind or shade the fastening systems which hold the shade open can match or be compatible with the fastening systems in the other end of the shade so that either end of blind 106 or 314 can be attached to bracket 101 or 301 respectively, and the other end can attach to a window frame using the other part of the fastening system.

In either the rectangular 100 or semi-circular 300 embodiments of the blind or shade, a first pattern may be provided on the inside-facing portion of the shade so that the first pattern is visible from the inside of a room. A second color or pattern may be provided on the outside-facing portion of the shade so that the second color or pattern is visible from the outside of the room or building through the window or opening. The second pattern may be the same or different from the first pattern. Other decorative aspects of this invention can include one or both sides of covers 304 and 311 of bracket 301, brackets 101 or 301 themselves, pegs 109 (if used), clip or clips 112, and cover 110.

As an example of installing this blind system on a rectangular window, first one can measure the window width and length. Then cut or snap off bracket 101 and cover 110, and cut or tear off (if there are premade perforations) the side or sides of blind 106 to match the width of window 102. Cut or tear off excess length of blind 106 to match the height of window 102, such that blind 106 comfortably covers window 102 when blind 106 is unfolded. Then, attach bracket 101 to window 102 or to the frame of window 102 using adhesive 103 or any other attachment system provided. Then place reinforced section 107, if provided, of blind 106 against bracket 101 in such a way as to line up holes 108 on blind 106 with holes 105 in bracket 101, and place pegs 109 into holes 105 in bracket 101. Then place cover 110, if provided, over bracket 101.

When it is desired to change out rectangular blind 106, because of decorative or wear issues, one can remove cover 110, and pegs 109, if used. Then blind 106 can be removed from bracket 101 and a replacement blind can be sized and placed on bracket 101, lining up its holes 108 with holes 105 on bracket 101 and replacing pegs 109. Then cover 110, which may be the same one as previously used or may be different if it is intended to decoratively match the blind 106, is placed back on bracket 101.

As an example of installing this blind system on a semi-circular window, first one can measure the radius of the window (or the full width at the bottom of the semi-circular portion and divide by two). Then, if a long bracket 301 is being used, it can be shortened by means including, but not limited to, cutting, snapping off, or telescoping to fit the window width. Since this bracket 301 only needs to be slightly wider than then notch 315, a bracket shortening step may not be needed. Then, attach outer cover 304, if cover 304 is removable for decorative purposes, to bracket 301, and install bracket 301 on window 601 or window frame 602 using adhesive 302 or 303 respectively or other attachment systems described. Cut or tear (if perforations in the blind are used) one end of the blind 604 so that when the pleats are fanned out the blind's coverage will match the radius of the window 601. A template may be desirable for this step, particularly for a complex shape like arched or rectangular, and can be provided with the blind. Then place the lower end 316 of blind 314 into notch 315, using any additional retaining systems such as wedge 317, and attach inner cover 311 to bracket 301 to hold lower end 316 of blind 314 in notch 315. Then one or both edges of the pleated blind 604 can be spread out, fan-wise, to partially or completely cover semi-circular window 601. If desirable, one 607 or both edges of blind 604 can be attached to window frame 602 using systems such as, but not limited to, weights, adhesive, magnets, an installable catch, or hooks and loops such as Velcro™.

When it is desired to change out a blind 314, one need only remove inner cover 311 and, if used, additional retaining system 317, pull lower end 316 of blind 314 out of notch 315, and insert lower end 316 of a different blind, perhaps with different decoration, into notch 315, replacing retaining system 317 and cover 311. In this way, bracket 301 stays in place, making it convenient and fast to change out the main decorative or disposable element blind 314. If covers 304 and 311 are significant decorative elements and will be changed out frequently with blind 314, perhaps matching the blind in theme, outer cover 304 may be designed to, for example, slide up and out from behind bracket 301 without removing bracket 301 from the window or frame. Tracks or notches may be used to allow this upwards or sliding removal of outer cover 304.

In addition to providing decorative covers for windows, as previously described, embodiments of this invention may be used to cover windows for thermal reasons. In order to do this, the temporary blind may be trimmed to be wider and longer than just the glass in the window, so that the edges overlap onto the frame around the window. The excess edges can then be sealed against the frame, using systems including, but not limited to, heat shrink, adhesive or tape. The easy interchangeability of blinds with this invention allow such a substitution to be made only for particularly cold or hot weather, after which the insulating or sealed blind can be removed. The insulating or sealed blind can be an ordinary single layer of pleated material, or could include a thicker layer of material like bubble wrap or open or closed cell foam, to provide more significant insulation. The insulated layer could be primarily or exclusively over the glass portion of the window, with a thinner strip around the edges of the blind to make it easier to seal against the frame of the window.

While embodiments of this invention describe pleated blind material for the removable blind portion, it is clear that other ways of collapsing, compressing or storing the blind material when it is not covering the window could be used, particularly for the rectangular blinds. These ways include, but are not limited to, rolling the blind material, folding the blind material, or crumpling the blind material. If rigid materials are used for the removable blind portion, horizontal or vertical slats could be used, which could be rolled, tied, or angled to change the portion of the window they cover. The primary embodiments of this invention do not include complex mechanical components (strings, pulleys, hinges, etc.) in the replaceable blind section.

Since this invention is aimed at convenient changing out of blinds from the holders, decorative elements may be used extensively on the blinds in any embodiment of the invention. This allows selling blinds with different decorative elements more inexpensively than would be the case if the brackets needed to be included with each blind, and also allows for selling decorative elements separately from the blinds 106 or brackets 101 or 301, which decorative elements could then be applied to the blinds or brackets. These decorative elements could be identical or different on the inside facing and outside facing sides of the blinds. They could include seasonal elements, such as flowers in the spring, leaves in the fall, snowflakes in the winter, and so on. They could include holiday elements, such as wreaths or reindeer around Christmas, fireworks for the Fourth of July, and so on. They could include elements related to specific events, such as birthdays, anniversaries, weddings or baby showers. They could include sporting related events, such as logos for particular teams, a World Series, a Super Bowl, the Olympics, or a World Cup soccer match. Brackets 101, covers such as 110 and clips such as 112 may have images or colors to match these decorative elements on the blinds, if they are visible.

In addition to purely decorative patterns, these blinds may be changed out to change functional properties of the blinds, such as opacity. For some circumstances only privacy shades may be desired, so that as much light as possible is allowed into the building, while in other circumstances, such as when someone changes to a night shift and needs more light blocking, room darkening shades may be used. Shades may also have reflective, transparent and/or prismatic elements incorporated, to send decorative or colored beams of light around the room or to provide a “stained glass” appearance for the window.

While embodiments of this invention describe covering a window and in some cases use the term “window blind”, the support brackets for the blinds could be used to cover any opening, such as providing a temporary covering for a window air conditioner or window air conditioner hole, a doorway, an HVAC vent, or an opening left in a building during construction. These other applications of the subject invention may particularly lend themselves to use of the insulated blind described earlier, but could also be used to provide temporary coverings for an interior doorway, for example for privacy or for decoration for a special occasion.

It should be understood that the foregoing description is only illustrative of the embodiments. It should also be understood that the embodiments disclosed herein may be used individually or in any suitable combination thereof. Various alternatives and modifications can be devised by those skilled in the art without departing from the embodiments. Accordingly, the present embodiments are intended to embrace all such alternatives, modifications and variances.

What is claimed is:

1. An assembly for covering a portion of a surface or opening with a blind, the assembly comprising:
a bracket, comprising a length, an upper portion, a rear portion, a bracket attachment element capable of attaching the bracket to the surface or opening edge without damage to that surface or opening edge, and
a blind retainer element which allows replacement of the blind without removing the bracket from the surface or opening edge, the blind being attachable to the blind retainer element while the blind is in a collapsed state, the collapsed blind being spreadable to cover essentially the entirety of the portion of the surface or opening, the blind comprising a top end and a bottom end, a first side edge and a second side edge, an inside-facing portion, and an outside-facing portion, the blind being attached to the blind retainer element at one end or edge of the blind.

2. The assembly of claim 1 wherein the bracket attachment element further comprises an adhesive provided on the portion of the bracket facing the surface or opening edge.

3. The assembly of claim 1 wherein the surface comprises a glass window.

4. The assembly of claim 3 wherein the blind can be attached on at least one of the blind's ends or edges other than the end or edge attached to the blind retainer element to the surface or opening edge when the blind is spread out.

5. The assembly of claim 4 wherein the blind is comprised of material having insulating properties against conductive heat transfer.

6. The assembly of claim 1 wherein the blind retainer element further comprises a plurality of pegs provided on the front portion of the bracket, and wherein the blind further comprises a plurality of holes along the top edge of the blind, which holes match the pegs on the blind retainer element.

7. The assembly of claim 1 wherein the blind retainer element further comprises a spring clip to hold the top edge of the blind.

8. The assembly of claim 1 wherein the blind is shaped to cover a rectangular window.

9. The assembly of claim 1 wherein the blind further comprises a design pattern provided on a portion of the blind chosen from the group of the inside-facing portion and the outside-facing and both the inside and outside-facing portions of the blind.

10. The assembly of claim 1 wherein the blind retainer element further comprises a decorative cover to cover a portion of the bracket.

11. The assembly of claim 1 wherein the blind is vertically collapsed, with a compressed lower end of the blind placed removably in the blind retainer element, such that the upper portion of the blind can be spread to cover an approximately semi-circular window.

12. The assembly of claim 11 wherein the lower end of the blind is held in the blind retainer element by a movable piece.

13. The assembly of claim 1 wherein the assembly contains no complex mechanical systems.

14. A method for covering a window having a height, a width, and a top portion, the window in a window frame, the method comprising:
providing a collapsed blind having a top end and a bottom end, a first side edge and a second side edge, an inside-facing portion, and an outside-facing portion; reducing the width of the blind to a desired width if the width of the unfolded blind would be greater than the width of the window, by removing portions chosen from the group of the first side edge and second side edge, thereby making the final width of the blind approximately equal to the width of the window; providing a bracket comprising an original length, a front portion, a rear portion, a window attachment element, and a blind retainer portion for the collapsed blind; removably attaching the bracket to the top portion of the window or the window frame, removably fastening an end or side of the blind to the bracket by using the blind retainer portion; and unfolding the collapsed blind to cover a portion of the height of the window.

15. The method of claim 14 further comprising insulating the window by providing a collapsed blind having thermally insulating properties, and removably fastening at least one end or side of the blind to a frame of the window.

16. The method of claim 14 further comprising attaching the bracket to the top portion of the window or the window frame by providing an adhesive on the rear or upper portion of the holder, and adhering the rear or upper portion of the holder to the window or window frame.

17. The method of claim 14 further comprising attaching the pleated blind to the bracket by providing a plurality of pegs on the front portion of the bracket; providing a plurality of holes in proximity to the top edge of the blind; and positioning the plurality of holes in the blind over the plurality of pegs on the bracket.

18. The method of claim 14 further comprising attaching the pleated blind to the bracket by collapsing the blind by vertically pleating the blind, placing the compressed bottom end of the pleated blind in a retainer portion of the bracket; shortening the top end edge of the pleated blind if necessary to match the approximate radius of an approximately semi-circular window, unfolding the side edges of the pleated blind; and securing the side edges of the blind to the window frame.

19. The method of claim 18 further comprising applying a removable blind retaining element and thereby securing the compressed bottom end of the collapsed blind in the retainer portion.

20. The method of claim 14 further comprising providing a design pattern on a portion of the blind chosen from the group of the inside-facing portion and the outside-facing and both the inside and outside-facing portions of the blind.
